(19) United States
(12) Patent Application Publication
(10) Pub. No.: US 2026/0022959 A1
(43) Pub. Date: Jan. 22, 2026

(54) DEVICE WITH FLOWMETER AND NOZZLE FOR EXACT DOSING

(71) Applicant: Carlos Augusto DE ROSENZWEIG PAGES, Nuevo León (MX)

(72) Inventor: Carlos Augusto DE ROSENZWEIG PAGES, Nuevo León (MX)

(21) Appl. No.: 18/875,405

(22) PCT Filed: Jun. 14, 2022
(86) PCT No.: PCT/MX2022/050047

§ 371 Date: Dec. 16, 2024

(51) Int. Cl. G01F 11/00; G01F 11/12

(52) U.S. Cl. CPC G01F 11/006; G01F 11/12

(57) ABSTRACT

The present invention relates to a device with a dosing nozzle and an integrated flowmeter, which has the advantage of comprising, in a single body, a dosing nozzle for filling with products and which is equipped with an oval-gear volumetric flowmeter and a control chip for autonomous dosing. According to the invention, integrated into a single body are a main case with a cavity for accommodating the oval gears, a cavity for accommodating an electronic control chip, and a mechanically, pneumatically or electromechanically actuated dosing nozzle which is actuated by means of a pneumatic, mechanical or electromagnetic actuator, to correctly open the nozzle and control same throughout the dosing process; the oval-gear flowmeter is equipped with a permanent magnet with fields aligned with the axis of rotation and is mounted on one of the shafts of the gears to enable same to be read contactlessly, and to prevent contamination by the control chip, using an integrated circuit for detecting the rotation of the gear. A pneumatic valve of the detachable nozzle can be placed in the body to dispense with the handling of separate valves and hoses of each nozzle.

### CROSS REFERENCE TO RELATED APPLICATION

This application claims the benefit under 35 U.S.C. § 371 to international application No. PCT/MX2022/050047, filed on Jun. 14, 2022, the content of which is incorporated by reference herein in its entirety.

### FIELD OF INVENTION

The present invention relates to a comprehensive system for accurately dosing a product, contained in a single unit, that allows the automation of the process to be used in packaging machinery.

### BACKGROUND

Currently, to fill containers or packages accurately, different types of flowmeters are used, some of these are oval gears, and after the flowmeter is installed some type of filling nozzle for packages or containers, in this way there is no communication or relationship between the flowmeter and the nozzle, and their only relationship is that the flowmeter delivers a measured amount of flow to the nozzle.

In the prior art, document U.S. Pat. No. 10,161,777, which refers to a flowmeter with a magnetically actuated flow restriction valve, which includes a valve that has a pressure vessel that provides a flow path from the inlet of the meter to meter outlet through the valve is magnetically driven. The meter includes a valve member positioned within the valve in the pressure vessel for movement between an open position that allows normal flow through the flow meter and a flow restricting position in which flow through the meter flow is limited to less than normal flow, and has electrically operable control device to control the movement of the valve member that includes a dry side magnet assembly and a wet side magnet assembly. The electrically operable control device receives command signals to rotate the dry side magnet assembly to move the valve member and thereby increase or decrease the flow through the metering chamber.

Document US2009314115A1 was also found, which consists of a flowmeter with spiral gear teeth for a fluid dosing device, which features a set of oval gears for use in a flowmeter comprising first and second gears that are identical to each other and that are configured to mesh at a fixed distance from center to center so that the first and second gears mesh in all directions. angular positions. Each gear of the oval gear set comprises a hub and a plurality of gear teeth. The hub comprises an oval body having a major axis and a minor axis extending through a center of the hub, and a root profile wall circumscribing the major and minor axes. The plurality of gear teeth extend from the wall of the root profile, each of the gear teeth has a pair of contact surfaces with circular involute curve profiles.

Document WO2017070401, refers to a flowmeter consisting of an oil consumption control device capable of accurately measuring extremely small volumes of oil entering the sump in real time, the oil flow data being processed “locally” by a microprocessor that is mounted on the engine and combined with time stamp information (both calendar time and machine running time), the oil flow data processed by the microprocessor is then transmitted over the Internet to a database server where they are cataloged and sent to the application server for further analytical data processing. The remote application server processes the inputs from the remote field flow measurement devices into “actionable information”.

However, none of the documents cited above have an encoder in the flowmeter, nor an electronic card that controls the opening at two speeds of the nozzle, including a total closure of said nozzle, nor do they disclose a device that incorporates in a single compact unit the nozzle, the flowmeter, the card and the nozzle closing mechanism.

### SUMMARY

The disadvantages heretofore associated with the prior art are overcome by the present invention of a device with a dosing nozzle and an integrated flowmeter, which has the advantage of comprising, in a single body, a dosing nozzle for filling with products and which is equipped with an oval-gear volumetric flowmeter and a control chip for autonomous dosing. According to the invention, integrated into a single body are a main case with a cavity for accommodating the oval gears, a cavity for accommodating an electronic control chip, and a mechanically, pneumatically or electromechanically actuated dosing nozzle which is actuated by means of a pneumatic, mechanical or electromagnetic actuator, to correctly open the nozzle and control same throughout the dosing process; the oval-gear flowmeter is equipped with a permanent magnet with fields aligned with the axis of rotation and is mounted on one of the shafts of the gears to enable same to be read contactlessly, and to prevent contamination by the control chip, using an integrated circuit for detecting the rotation of the gear. A pneumatic valve of the detachable nozzle can be placed in the body to dispense with the handling of separate valves and hoses of each nozzle.

More specifically, in one embodiment, a device with a flowmeter and nozzle for exact dosing, comprises: a main housing (3) which has in its rear part a tubular projection (25) through which the fluid enters, said main housing (3) has in its central part an oval cavity (26), in communication with the projection (25), where a first and second oval gears (18 and 19) are housed, held in its central part with a rotation axis (23), where the first oval gear (18) has in its upper part a protuberance (20) inside which a magnet (21) is contained, said main housing (3) has on its front side a tubular outlet conduit (7) arranged vertically which has a transverse opening in communication with the oval cavity (26), such that the fluid enters through the tubular projection (25) passes through oval cavity (26) causes rotating the gears (18 and 19), thereby carrying out the flow measurement, continuing towards the tubular outlet conduit (7); a substantially rectangular side casing (46) with a central cavity with a recess (22) coinciding with the protuberance (20) of the first gear (18), said central cavity houses an electronic control card (17), said side casing (46) is coupled to a lateral side of the main casing (3), where the electronic control card (17) has an encoder (24) aligned with the magnet (21) of the first gear (18); at least one actuating means connected to the upper part of the tubular outlet conduit (7), by means of which the output of the fluid coming from the oval cavity (26) is controlled, this actuating means (13 and 14) is selected from the pneumatic or stepper motor type or both; a nozzle (6) arranged at the bottom of the outlet tubular conduit (7) through which the product will be finally dispensed.

In one aspect, the device with a flowmeter and nozzle for exact dosing has an integral upper part with a fixing handle substantially in the form of an “L” defining an open space to place it in the required place and subsequently place a rectangular bar (4) with a hole through it so that a bolt (45) with a knob (5) with a hexagonal seat is introduced, closing the handle of the main housing (3) and keeping it fixed in the required place.

In another aspect of the device with a flowmeter and nozzle for exact dosing, the projection (25) is defined by a pin to be coupled to a conduit (11) through which the fluid enters the device and is fixed by means of conventional screw-type clamps (12).

In a further aspect, the device with a flowmeter and nozzle for exact dosing, the magnet (21) is embedded, or a circular Teflon plug (51) is included to receive the shaft (23) and seal the magnet (21) in the upper part of the first gear (18).

In a further aspect of the device with a flowmeter and nozzle for exact dosing, around the oval cavity (26) there is a peripheral groove to house a sealing O-ring (47).

In still another aspect of the device with a flowmeter and nozzle for exact dosing, the side casing (46) is coupled to a lateral side of the main casing (3) by means of perforations and Allen bolts (42).

In yet another aspect of the device with a flowmeter and nozzle for exact dosing, the side casing (46) has a cover (44) to close the central cavity and protect the electronic card (17), said cover (44) is coupled by means of holes (30) and screws (31).

In a further aspect of the device with a flowmeter and nozzle for exact dosing, on one side of the side casing, in an upper corner, there are built-in male connectors with cable (9 and 10) for supplying electric power to the electronic control card (17). In another aspect, the device with a flowmeter and nozzle for exact dosing includes an O-ring (50) between the outlet tube (7) and the nozzle.

In still a further aspect of the device with a flowmeter and nozzle for exact dosing, the control card (17) has a microprocessor (24) that controls and reports the process, with network communication, which allows viewing and modifying operating parameters even when the flowmeter is in use, and also controls the opening and closing of the nozzle (6) at two predetermined speeds or flows, first supplying a fast flow or speed until reaching a predetermined volume, approximately 90% of the volume to be dosed quickly and then a slow flow or speed to achieve the closing of the nozzle when reaching the desired volume.

In an aspect of the device with a flow meter and nozzle for exact dosing, the actuating means (13, 14) is configured to open the opening of the outlet tubular conduit (7), controlling it, opening it to 100% at the beginning and closing it to 90% when reaching 95% of the filling volume.

In another aspect of the device with a flow meter and nozzle for exact dosing, the permanent magnet (21) has fields aligned to the axis of rotation, mounted on one of the axes (23) of the gears so that it can be read without contact, and avoid contamination with the control card (17), by means of an integrated circuit (24) to detect the rotation of the gear without direct contact, (encoder type) of high resolution.

In a further aspect of the device with a flowmeter and nozzle for exact dosing, the card (17) can receive digital emergency stop signals and can also send digitally or via network signals such as end of cycle, error, among others.

In even another aspect, the device with a flowmeter and nozzle for exact dosing includes a protective cover (2), arranged on the side casing to cover the components of the actuating means.

In yet another aspect of the device with a flowmeter and nozzle for exact dosing, the pneumatic actuator (14) is made up of a diaphragm (38), a push rod (27), a push rod (36), a second diaphragm (29), a cover (37) and a pneumatic connector (28), and includes a solenoid valve solenoid (15), a solenoid valve body (16), a pneumatic connector (33), a pneumatic exhaust silencer (34) and a second pneumatic connector (35).

In still a further aspect of the device with flowmeter and nozzle for exact dosing, the stepper motor (13) is made up of a motor housing (39), a threaded motor rod (41), a guide duct (40), a mounting cap (42), a lower guide (43) and a diaphragm (48).

### BRIEF DESCRIPTION OF THE FIGURES

FIG. 1 is a perspective view of the dosing device with flowmeter and nozzle in a first pneumatic mode.

FIG. 2 is a perspective view of the dosing device with flowmeter and nozzle in a second mode with stepper motor.

FIG. 3 is a perspective view of the dosing device with flow meter and nozzle in a first pneumatic mode without the protective cover.

FIG. 4 is a perspective view of the dosing device with flowmeter and nozzle in a second mode with stepper motor, without the protective cover.

FIG. 5 is a perspective view of the dosing device with flowmeter and nozzle in a second mode with stepper motor showing the electronic card.

FIG. 6 is a perspective view of the dosing device with flow meter and nozzle in a first pneumatic mode showing the electronic card.

FIG. 7 is a perspective view of the dosing device with flowmeter and nozzle showing the interior of the housing with oval gears and other elements in common between both modalities.

FIG. 8 is a side sectional view of the dosing device with flow meter and nozzle in a second mode with stepper motor.

FIG. 9 is a close-up view A inside section of the dosing device with flow meter and nozzle.

FIG. 10 is a longitudinal sectional view of the dosing device with flow meter and nozzle in a first pneumatic mode.

FIG. 11 is a view of a close-up B in longitudinal section of the dosing device with flow meter and nozzle showing the oval magnets.

FIG. 12 is a view of an approach C in longitudinal section of the pneumatic means of the dosing device with flowmeter and nozzle in a first pneumatic mode.

FIG. 13 is a longitudinal sectional view of the dosing device with flow meter and nozzle in a second mode with stepper motor.

FIG. 14 is a view of a close-up D in longitudinal section of the stepper motor of the dosing device with flow meter and nozzle in a second pneumatic mode. FIG. 15 is a longitudinal sectional view of the dosing device with flowmeter and nozzle showing the flow of the fluid.

FIG. 16 is a sectional view from the top of the dosing device with flowmeter and nozzle in a second embodiment with a stepper motor.

FIG. 17 is an exploded perspective view of the dosing device with flowmeter and nozzle showing the parts of the two modalities.

FIG. 18 is an exploded perspective view of the dosing device with flow meter and nozzle in its first pneumatic mode.

FIG. 19 is an exploded perspective view of the dosing device with flow meter and nozzle in a second mode with a stepper motor.

FIG. 20 is an exploded perspective view of the dosing device with flow meter and nozzle of the parts in common between the two modalities.

FIG. 21 is an exploded perspective view of the dosing device with flow meter and nozzle in a first pneumatic mode.

FIG. 22 is a perspective view of the flow meter dosing device with different nozzles that can be assembled to the outlet duct.

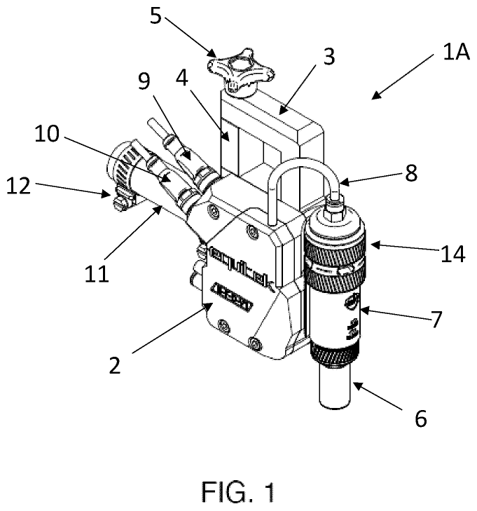

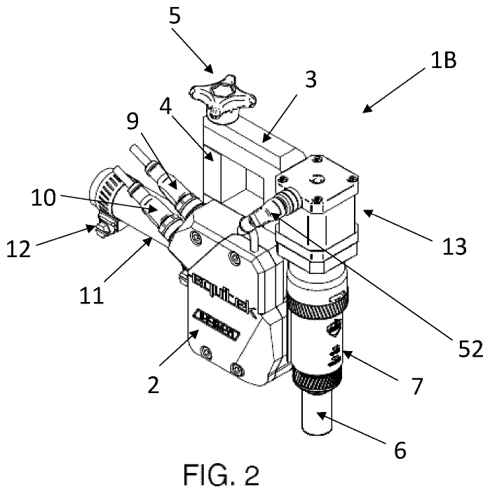

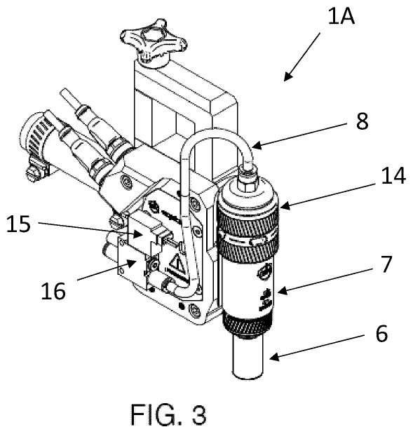

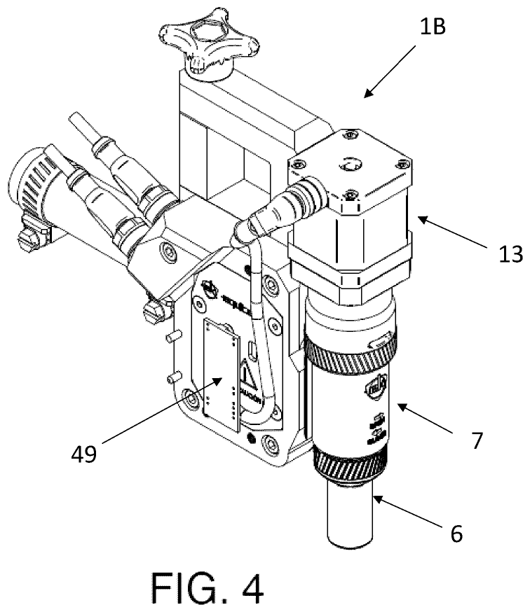

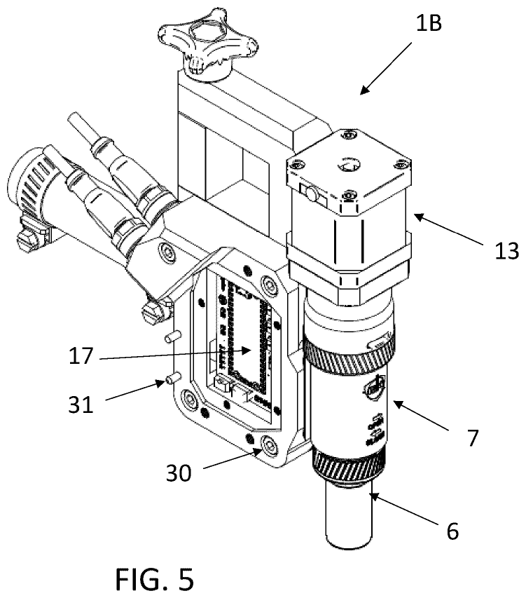

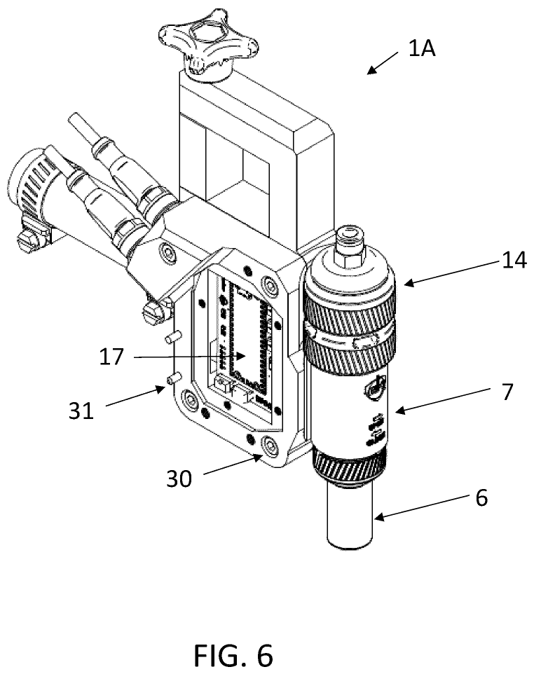

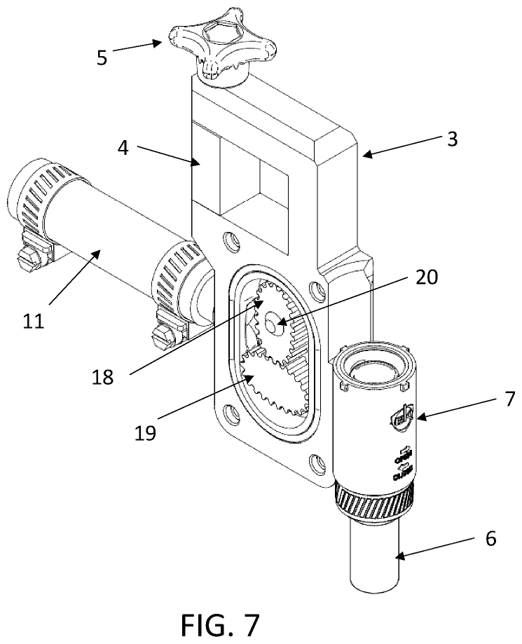

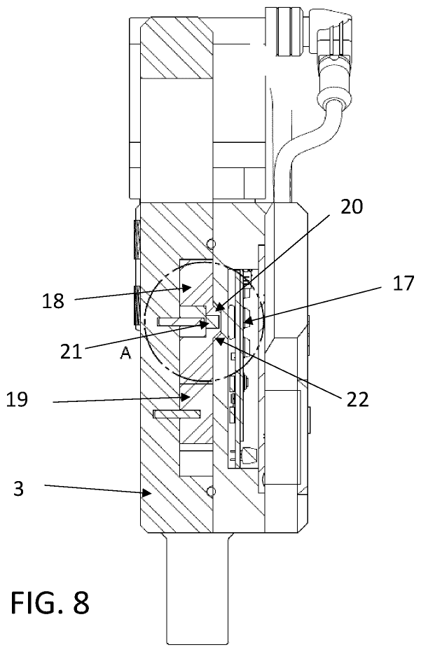

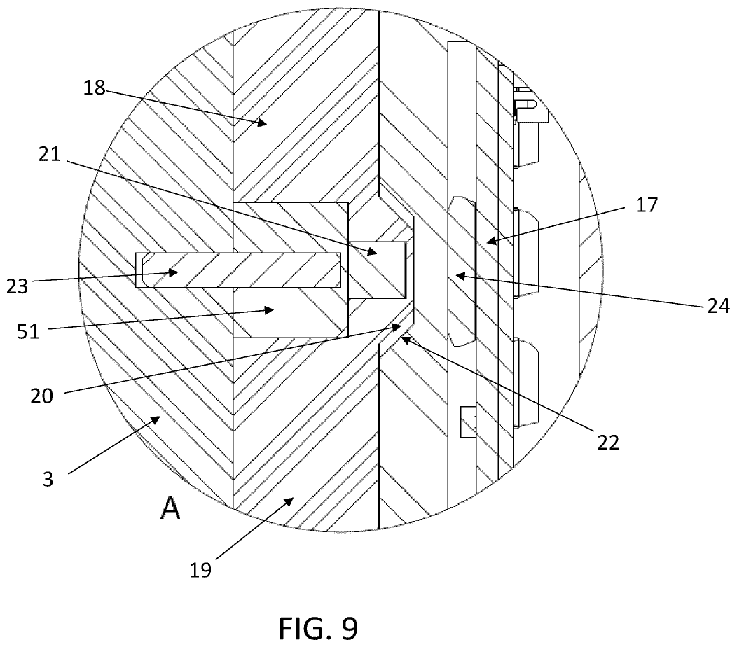

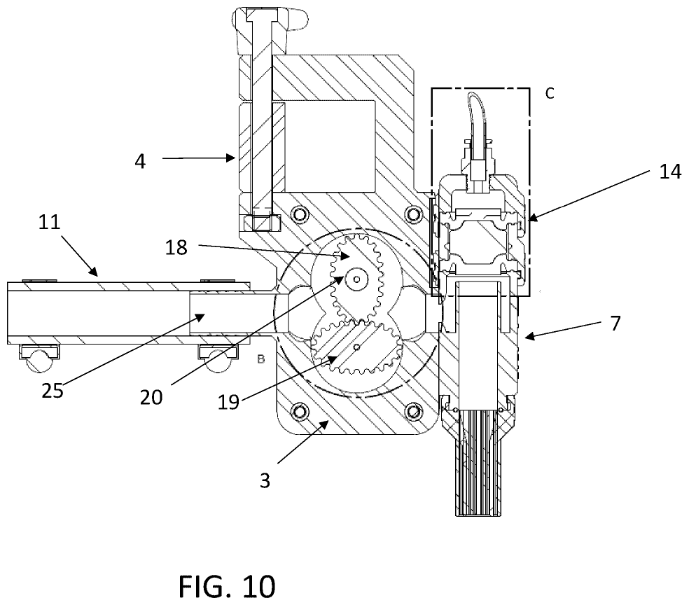

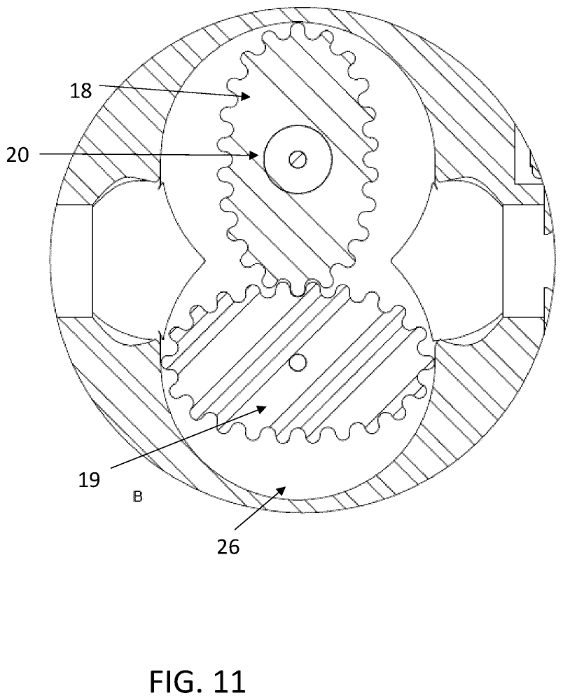

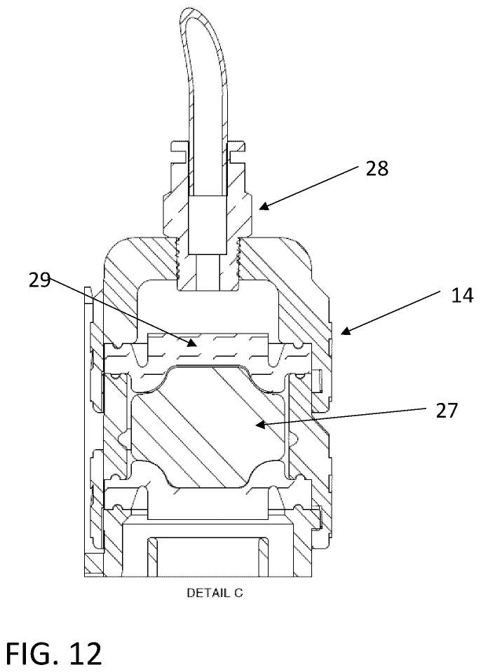

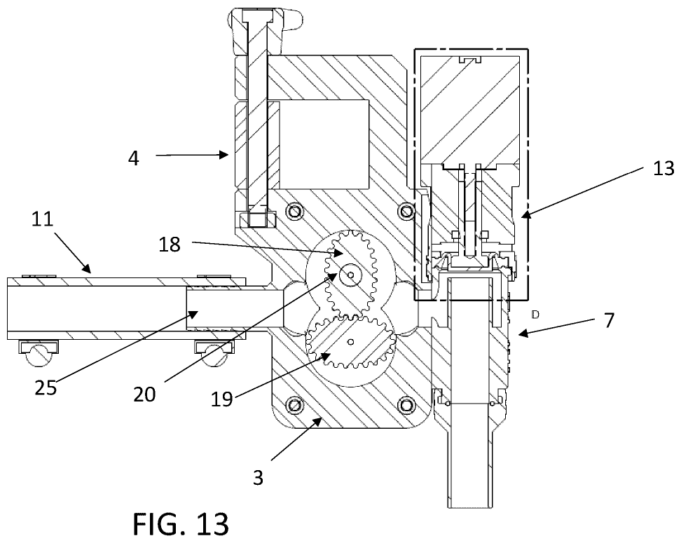

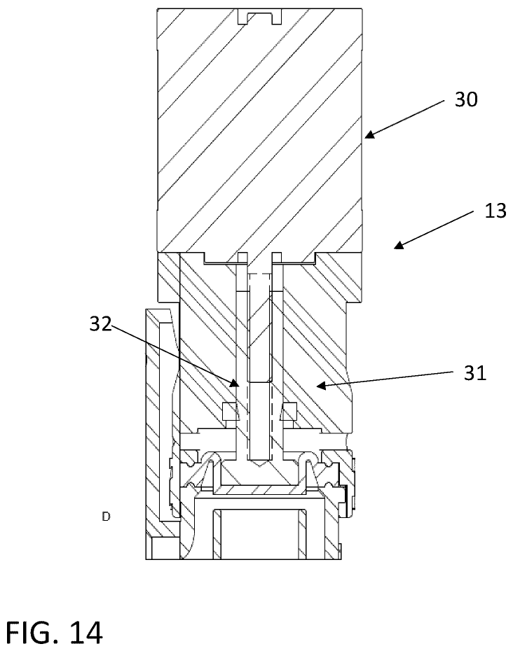

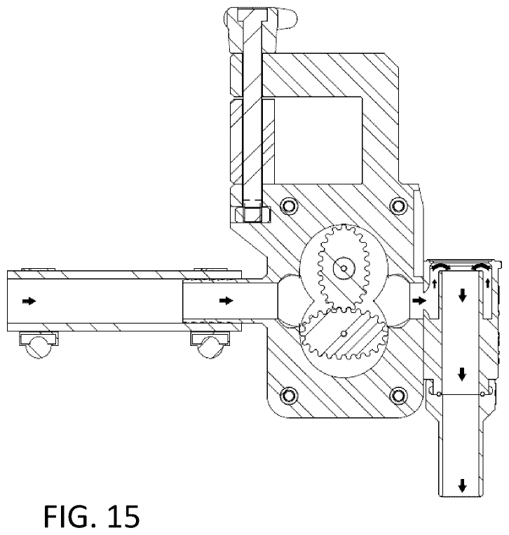

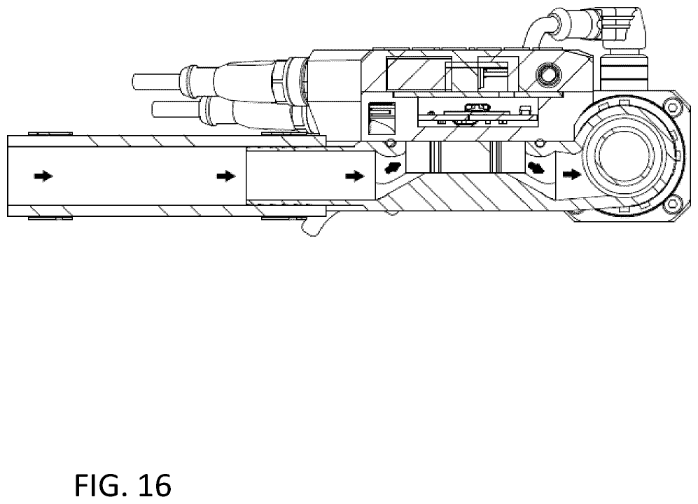

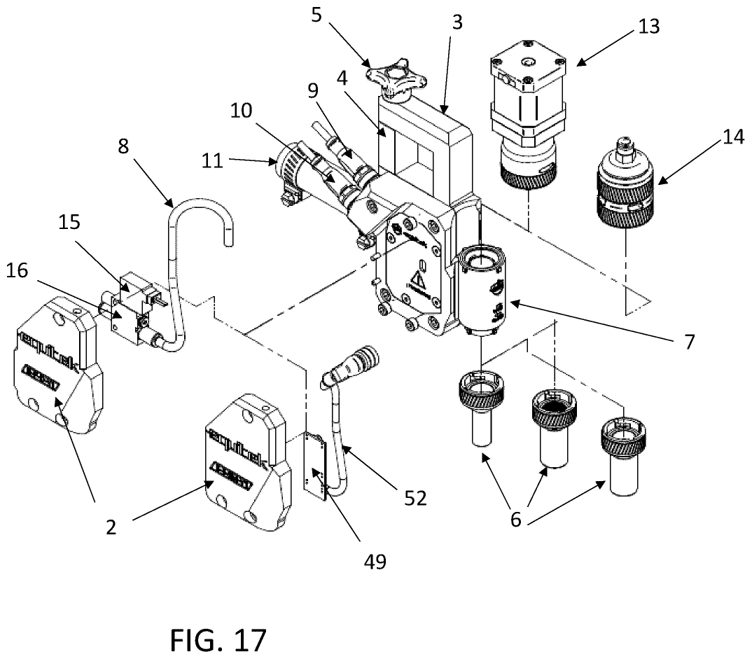

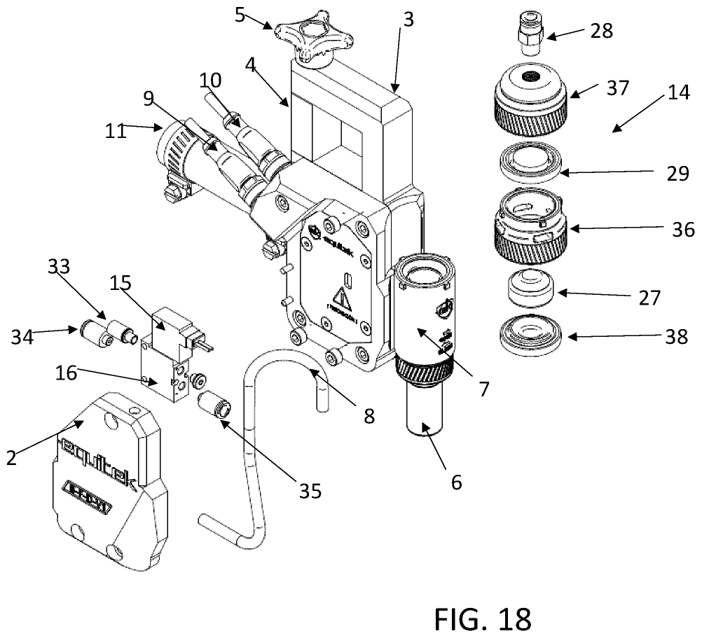

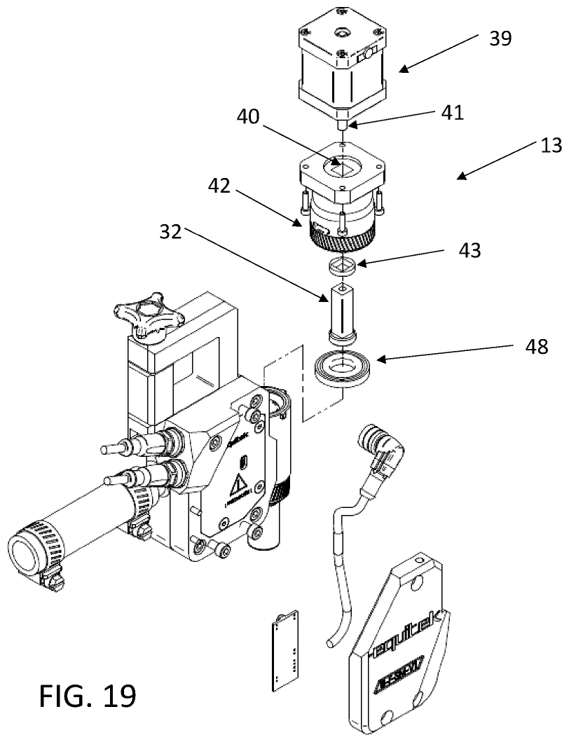

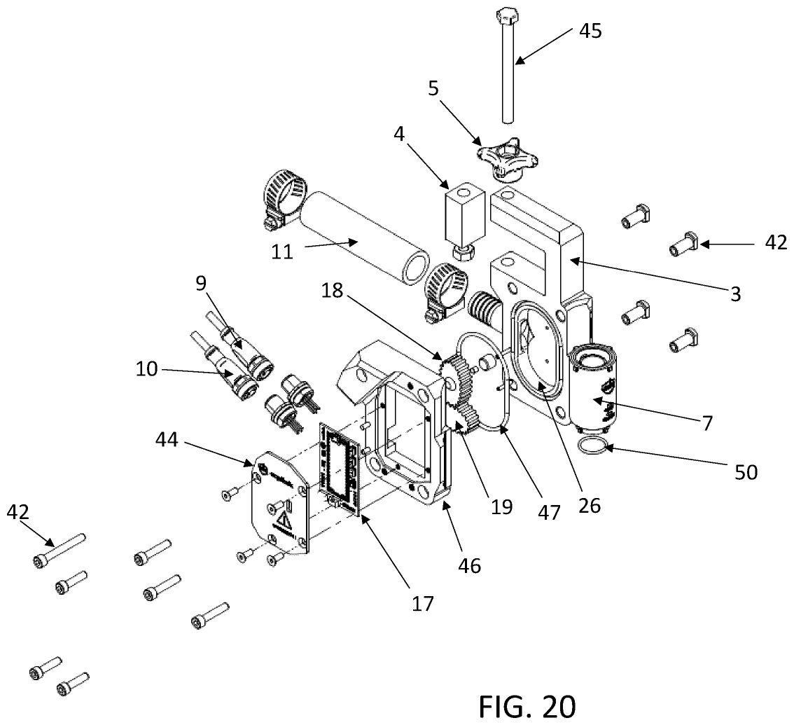

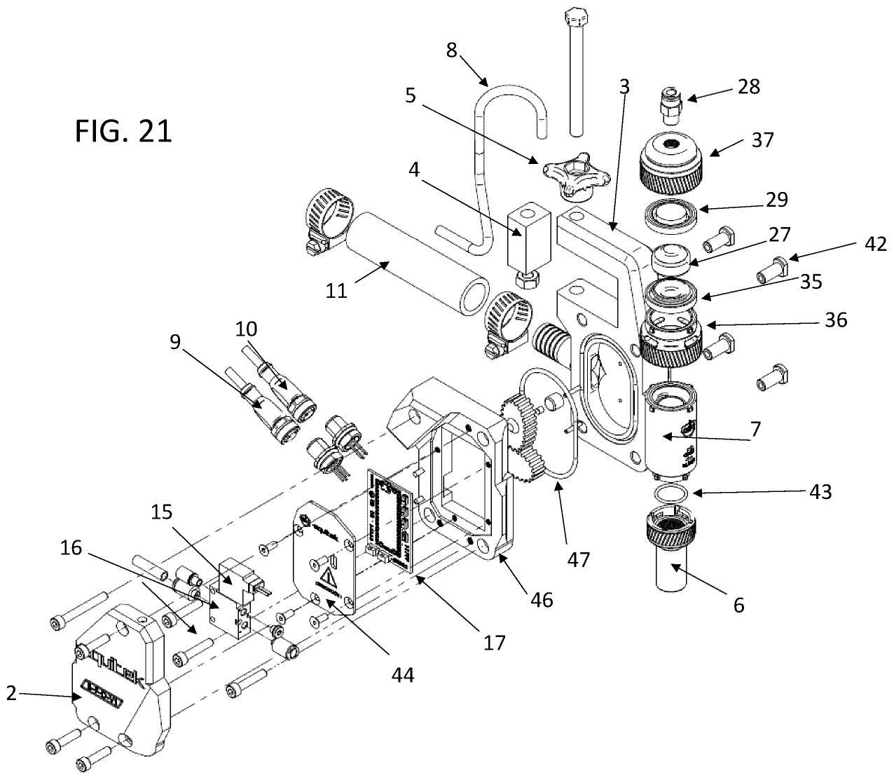

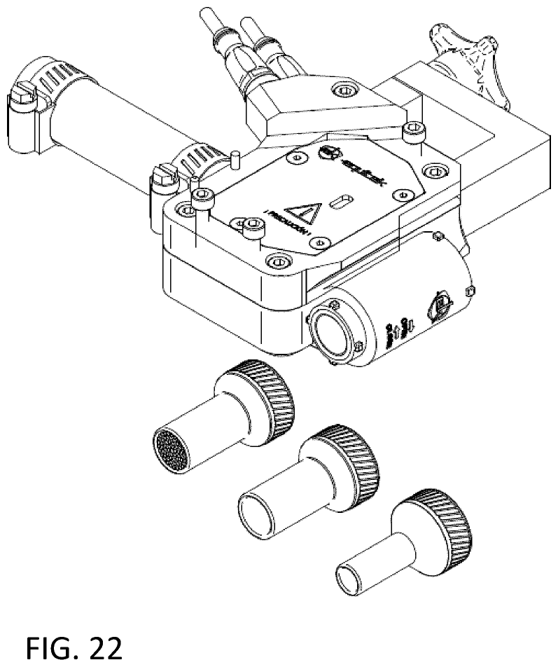

### DETAILED DESCRIPTION

The device of the present invention comprises a housing (3) that has a connection (25) for the entry of product, a volumetric cavity (26) of the volumetric flowmeter, a tubular outlet duct (7) electrically operated by means of a stepper motor (13) or by pneumatic means (14), a nozzle (6) to be mounted on a nozzle holder at the lower end of the tubular outlet duct (7) which several units can be mounted in parallel to form part of a packaging equipment, and an electronic motor control card (49), if a stepper motor (13) is used, which allows the autonomous operation of the same for dosing the product into a container or container automatically and repetitive.

The device of the present invention comprises a main casing (3), which has an integral upper part with a fixing handle substantially in “L” shape defining an open space to place it in the required place and then place a rectangular bar (4) with a through hole so that a bolt (45) with a knob (5) with a hexagonal seat is inserted, closing the handle. the main casing (3) and keeping it fixed in the required place.

The main housing (3) has on its rear part a tubular protrusion (25) through which the fluid enters, said protrusion (25) can be defined by a spike to attach a conduit (11) through which the fluid enters the device and can fixed by means of conventional screw-type clamps (12), said main housing (3) also has in its central part an oval cavity (26), in communication with the projection (25), where a first and second are housed. oval gears (18 and 19) held in their central part with a rotation axis (23), where the first oval gear (18) has in its upper part a protuberance (20) within which a magnet is contained (21) preferably embedded, or may include a circular Teflon plug (51) to receive the shaft (23) and seal the magnet (21) in the upper part of the first gear (18), around the oval cavity (26). It has a perimeter groove to house a sealing O-ring (47).

The main casing (3) has on its front side a tubular outlet duct (7) arranged vertically which has a transverse opening in communication with the oval cavity (26), in such a way that the fluid enters through the projection (25) passes into the oval cavity (26) by rotating the gears (18 and 19), through which the flow measurement is carried out, and the fluid continues on its way to the tubular outlet conduit (7).

The device also has a substantially rectangular lateral casing (46) with a central cavity with a recess (22) coinciding with the protuberance (20) of the first gear (18), said central cavity houses an electronic control card (17), Said side casing (46) is coupled to a lateral side of the main casing (3) by means of perforations and bolts (42), preferably alien type.

Said electronic control card (17) has an encoder (24) being aligned with the magnet (21) of the first gear (18), the side casing (46) has a cover (44) to close the central cavity and protect the electronic card (17), said cover (44) is attached by means of holes (30) and screws (31). On one side of the lateral casing, preferably in an upper corner, there are recessed male connectors with cable (9 and 10) to supply electrical energy to the electronic control card (17).

The device also includes an actuator means, which can be of a pneumatic type (14) or a stepper motor (13) connected to the upper part of the tubular outlet duct (7), by means of which the outlet of the fluid is controlled. coming from the oval cavity (26), these actuator means (13 and 14) are the two options that the device has, you can have only one of them or you can have both options and select any, in the option with the motor In steps (13) the flow of the nozzle (6) can be regulated according to a filling pattern, while with the pneumatic actuator option, it is open or closed, it is not adjustable.

At the bottom of the tubular outlet duct (7), a nozzle (6) is removably connected by means of which the product will finally be dispensed, including between the tubular outlet duct (7) and the nozzle (6) a O-ring (50).

In the case of a first embodiment (1A) in which a pneumatic actuator (13) is used, the device includes a solenoid valve (15) and a solenoid valve body (16) connected to the pneumatic actuator (13) by a pneumatic hose (8), arranged adjacent to the cover (44) and protected by a cover (2).

In the case of a second modality (IB) in which a stepper motor (14) is used, the device includes a second electronic card for the control (49) of the stepper motor (13) connected to the stepper motor by a cable. (52), arranged adjacent to the cover (44) and protected by a cover (2).

In the first embodiment (1A) with a pneumatic actuator (14), this actuator is made up of a diaphragm (38), an element (27), a push rod (36), a second diaphragm (29), a cover (37) and a pneumatic connector (28).

In this pneumatic mode (1A), a solenoid valve solenoid (15), a solenoid valve body (16), a pneumatic connector (33), a pneumatic exhaust silencer (34) and another pneumatic connector (35) are included. In the second mode (IB) with a stepper motor (13), this actuator is made up of a motor housing (39), a threaded motor rod (41), a guide channel (40), a mounting cover (42), a lower guide (43) and a diaphragm (48).

By containing all these elements in a single unit, the space occupied by the different elements that make up the system is reduced, simplified and the cost reduced.

The control card (17) has a microprocessor (24) with the following functions:

Controls and reports the process, with network communication, which allows viewing and modifying operating parameters even when the flowmeter is in use, it also controls the opening and closing of the nozzle (6) at two predetermined speeds or flows, first supplying a fast flow or speed until reaching a predetermined volume, (for example 90%) of the volume to be dosed quickly and then a slow flow or speed to achieve closure of the nozzle when reaching the desired volume, operates through an algorithm with the which compares the dosing volume achieved with the target volume, and adjusts the change and cut-off points, progressively to achieve their optimization in each cycle.

The main feature of the device is to achieve that in a single unit the control and dosing function of product in a container is integrated automatically and that, due to its compact design, several units can be installed in parallel to integrate a packaging equipment already be linear or rotary.

This device has the advantage of having in a single unit dosing nozzle for filling liquid products equipped with a high-resolution oval gear volumetric flowmeter and a control card for autonomous dosing or filling operation.

This device is integrated with the following basic components:

A main housing (3), which will have a connection (25) to receive the product in communication with a cavity (26) in which the oval gears (18 and 19) are housed, a side housing (46) with a cavity central to house an electronic control card (17) and a dosing nozzle (6) actuated mechanically, pneumatically, or electromechanically. The tubular outlet duct (7) has an appropriate diameter according to the product and container or process to which it will be applied, which is activated by an actuator, whether pneumatic (14), mechanical or electromagnetic by means of a motor. steps (13) to achieve the appropriate opening of the tubular outlet conduit (7), and control it throughout the dosing process, being able, as an example, to open at 100% at the beginning, close at 90% when reaching 95% of the volume. achieved, to achieve a more exact dosage and close at the indicated time.

The flowmeter integrated in the main housing (3) has a pair of oval gears (18 and 19), where one of the oval gears (18) is equipped with a permanent magnet (21) with fields aligned to the axis of rotation, mounted on one of the axles (23) of the gears to be able to be read without contact, and avoid contamination with the control card (17), using an integrated circuit (24) to detect the rotation of the gear without direct contact, (encoder type) high resolution.

An electronic control card (17), which through microprocessors or the corresponding electronics will perform the following functions:

It receives the operating parameters, its status and the results of the process, through a communication network, which may be wired or wireless.

Upon receiving a digital or network signal, the card (17) will open the tubular outlet conduit (7) to begin filling.

The integrated circuit or encoder (24) will capture the rotation of the gear (18) magnetically and transform it into pulses, these in turn will be counted to measure the volume of product dosed, once the preset volume is reached, the card (17) will order the tubular outlet duct (7) to be closed, in order to repeat the cycle, the dosed volume can be evaluated and based on control algorithms, the cut-off points can be modified to achieve a more precise dosage.

The card (49) may include the control of a stepper motor (13), which through a spindle-type mechanism (32) can control the opening or closing of the tubular outlet duct (7) according to the displaced volumes. or fillings and manipulate the speed of the process to achieve more precise results. The card (17) may also receive digital emergency stop signals and may also send digitally or via network signals such as end of cycle, error, among others.

Another advantage of this device is that any quantity, depending on the type of network, can be easily integrated into a filling equipment, and the process controlled in a timely and autonomous manner, greatly simplifying the construction and control of the equipment.

The pneumatic valve (14) of the outlet tubular duct (7) can be placed in the main casing (3) to avoid handling separate hoses and valves for each nozzle. In case of failure, the tubular outlet duct can be replaced. outlet (7) through another easily, thus avoiding loss of time due to repair and/or maintenance, you can even have sets of nozzles dedicated to certain products to avoid cross contamination.

The present invention relates to a dosing nozzle with an integrated flowmeter, which has the advantage of having in a single body a dosing nozzle for filling liquid products equipped with a high-resolution oval gear volumetric flowmeter and a control card for easy operation. autonomous dosing or filling.

In this way, having the tubular outlet duct (7) with the actuator means and with the nozzle (6), after the flowmeter implies an enormous simplification in additional elements and their respective connection components, in addition to reducing energy expenditure in the transportation of the product and the saving of space in a filling line, obtaining a device that integrates all the elements or plurality of components in the same solution.

The ability to measure fluid at low speed (low flow) is something important to highlight, because the dynamics of the gears is directly proportional to the displacement of the product that makes it move.

Furthermore, by including a magnetic encoder (24), in the flowmeter it implies not having an arrow or contact with the outside, so it would not cause mechanical restriction, the high resolution of the magnetic encoder allows greater resolution with respect to traditional devices or with mechanical parts for sensing. Likewise, since the magnet (21) is arranged in the upper part of one of the axles (23) of the gear (18) defining an upper protuberance, protection is provided against pressure or impacts to the magnet, which could displace or misalign it, and The side casing (46) has a recess (22) coinciding with the protuberance (20) of the first gear (18), the encoder (24) of the electronic control card (17), is aligned and very close to the magnet (21).) of the first gear (18), this recess (22).

It serves to ensure that not the entire wall of the casing is thin, which would cause it to easily deform with the pressure of the fluid entering the flowmeter and due to the area it represents, allowing internal leakage and error in the measurement, if on the other hand, as in the present invention, a wall is maintained with sufficient thickness so that it does not deform and there is only a thinning of thickness in the recess (22), only in this area is there an approach so that the magnet (21) and the encoder (24), are close, without affecting the resistance to the flow pressure.

What is claimed is:

1. A device with a flowmeter and nozzle for exact dosing, comprising: a main housing (3) which has in its rear part a tubular projection (25) through which the fluid enters, said main housing (3) has in its central part an oval cavity (26), in communication with the projection (25), where a first and second oval gears (18 and 19) are housed, held in its central part with a rotation axis (23), where the first oval gear (18) has in its upper part a protuberance (20) inside which a magnet (21) is contained, said main housing (3) has on its front side a tubular outlet conduit (7) arranged vertically which has a transverse opening in communication with the oval cavity (26), such that the fluid enters through the tubular projection (25) passes through oval cavity (26) causes rotating the gears (18 and 19), thereby carrying out the flow measurement, continuing towards the tubular outlet conduit (7); a substantially rectangular side casing (46) with a central cavity with a recess (22) coinciding with the protuberance (20) of the first gear (18), said central cavity houses an electronic control card (17), said side casing (46) is coupled to a lateral side of the main casing (3), where the electronic control card (17) has an encoder (24) aligned with the magnet (21) of the first gear (18); at least one actuating means connected to the upper part of the tubular outlet conduit (7), by means of which the output of the fluid coming from the oval cavity (26) is controlled, this actuating means (13 and 14) is selected from the pneumatic or stepper motor type or both; a nozzle (6) arranged at the bottom of the outlet tubular conduit (7) through which the product will be finally dispensed.

2. A device with a flowmeter and nozzle for exact dosing of claim 1, which has an integral upper part with a fixing handle substantially in the form of an “L” defining an open space to place it in the required place and subsequently place a rectangular bar (4) with a hole through it so that a bolt (45) with a knob (5) with a hexagonal seat is introduced, closing the handle of the main housing (3) and keeping it fixed in the required place.

3. A device with a flowmeter and nozzle for exact dosing of claim 1, where the projection (25) is defined by a pin to be coupled to a conduit (11) through which the fluid enters the device and is fixed by means of conventional screw-type clamps (12).

4. A device with a flowmeter and nozzle for exact dosing of claim 1, where the magnet (21) is embedded, or a circular Teflon plug (51) is included to receive the shaft (23) and seal the magnet (21) in the upper part of the first gear (18).

5. A device with a flowmeter and nozzle for exact dosing of claim 1, where around the oval cavity (26) there is a peripheral groove to house a sealing O-ring (47).

6. A device with a flowmeter and nozzle for exact dosing of claim 1, where the side casing (46) is coupled to a lateral side of the main casing (3) by means of perforations and Allen bolts (42).

7. A device with a flowmeter and nozzle for exact dosing of claim 1, wherein the side casing (46) has a cover (44) to close the central cavity and protect the electronic card (17), said cover (44) is coupled by means of holes (30) and screws (31).

8. A device with a flowmeter and nozzle for exact dosing of claim 1, wherein on one side of the side casing, in an upper corner, there are built-in male connectors with cable (9 and 10) for supplying electric power to the electronic control card (17).

9. A device with a flowmeter and nozzle for exact dosing of claim 1, which includes an O-ring (50) between the outlet tube (7) and the nozzle.

10. A device with a flowmeter and nozzle for exact dosing of claim 1, wherein the control card (17) has a microprocessor (24) that controls and reports the process, with network communication, which allows viewing and modifying operating parameters even when the flowmeter is in use, and also controls the opening and closing of the nozzle (6) at two predetermined speeds or flows, first supplying a fast flow or speed until reaching a predetermined volume, approximately 90% of the volume to be dosed quickly and then a slow flow or speed to achieve the closing of the nozzle when reaching the desired volume.

11. A device with a flow meter and nozzle for exact dosing of claim 1, where the actuating means (13, 14) is configured to open the opening of the outlet tubular conduit (7), controlling it, opening it to 100% at the beginning and closing it to 90% when reaching 95% of the filling volume.

12. A device with a flow meter and nozzle for exact dosing of claim 1, where the permanent magnet (21) has fields aligned to the axis of rotation, mounted on one of the axes (23) of the gears so that it can be read without contact, and avoid contamination with the control card (17), by means of an integrated circuit (24) to detect the rotation of the gear without direct contact, (encoder type) of high resolution.

13. A device with a flowmeter and nozzle for exact dosing of claim 1, wherein the card (17) can receive digital emergency stop signals and can also send digitally or via network signals such as end of cycle, error, among others.

14. A device with a flowmeter and nozzle for exact dosing of claim 1, which includes a protective cover (2), arranged on the side casing to cover the components of the actuating means.

15. A device with a flowmeter and nozzle for exact dosing of claim 1, wherein the pneumatic actuator (14) is made up of a diaphragm (38), a push rod (27), a push rod (36), a second diaphragm (29), a cover (37) and a pneumatic connector (28), and includes a solenoid valve solenoid (15), a solenoid valve body (16), a pneumatic connector (33), a pneumatic exhaust silencer (34) and a second pneumatic connector (35).

16. A device with flowmeter and nozzle for exact dosing of claim 1, wherein the stepper motor (13) is made up of a motor housing (39), a threaded motor rod (41), a guide duct (40), a mounting cap (42), a lower guide (43) and a diaphragm (48).
